(19) United States
(12) Patent Application Publication
(10) Pub. No.: US 2006/0249013 A1
(43) Pub. Date: Nov. 9, 2006

(54) Jungle fighter aircraft conversion kit

(76) Inventor: David K. Harding, Haledon, NJ (US)

Correspondence Address: EDWARD M. LIVINGSTON, PA, 963 TRAIL TERRACE DRIVE, NAPLES, FL, 34103, US

(21) Appl. No.: 11/265,924

(22) Filed: Nov. 3, 2005

Related U.S. Application Data
(60) Provisional application No. 60/641,477, filed on Jan. 5, 2005.

(51) Int. Cl. F41A 23/00; B64D 7/00

(52) U.S. Cl. 89/37.16

(57) ABSTRACT

A jungle fighter aircraft conversion kit comprised of a gattling gun works (1) that is mounted at the nose cone (3) under portion of an aircraft (2), avionics grayboxes (8), vibration trays (5), a hood (9) for enclosure and a machine gun (10). The gattling gun works (1) is designed for repeat fire power in intermittent operations while the air vents (4) in the gattling machine gun works (1) are designed for cooling the weapon. The grayboxes (8) are located within the gattling works weapon (1) and are designed for control within the cockpit (7) of the aircraft. Both the weapon and the grayboxes (8) have vibration trays (5) mounted at each equipment base. The machine gun (10) is preferably compact and lightweight and similar in design to those used by United States secret service agents.

### CROSS REFERENCE TO RELATED APPLICATION

This application claims the benefit of U.S. Provisional Application No. 60/641,477, filed Jan. 5, 2005.

### BACKGROUND OF THE INVENTION

The present invention relates to jungle fighter aircraft, more particularly, a jungle fighter aircraft conversion kit that allows a person to modify an existing propeller aircraft or twin engine aircraft to a fighter aircraft suitable for use in jungles.

During the Vietnam war, F-4 and F-14 aircraft were used for combat. However, because the F-4 and F-14 are fast-traveling aircraft, they proved to be poor choices for combat use in Vietnam because they flew over the narrow and long Vietnam terrain too quickly to permit the firing of arms thereupon. In addition, the fighter pilots were cautious of trespassing on the airspace of Vietnam's neighbors.

Thus, it would have been more advantageous to use a slower-moving propeller aircraft, such as a twin-engine Cessna, in such a small area combat zone. However, commercial propeller aircraft are not equipped with artillery.

Companies such as Northrop Grumman have developed propeller aircraft capable for combat use in jungle and other small area combat zones. However, only wealthy countries such as the United States are able to take advantage of such an aircraft, thereby excluding third world countries from purchasing same. However, commercial propeller aircraft without artillery are within the budgetary realm of third world countries.

Thus, the need exists for a jungle fighter aircraft conversion kit which permits one to convert a propeller aircraft or twin engine aircraft into a true jungle fighter aircraft.

### SUMMARY OF THE INVENTION

The primary object of the present invention is to provide a jungle fighter conversion kit that allows for the modification of a commercial propeller or twin engine aircraft into a military aircraft.

Another object of the present invention is to provide a jungle fighter aircraft conversion kit that includes the addition of a weapon station.

A further object of the present invention is to provide a jungle fighter aircraft conversion kit that includes the addition of avionics grayboxes which may be controlled within the cockpit of the aircraft.

The present invention fulfills the above and other objects by providing a jungle fighter aircraft conversion kit comprised of at least one firearm secured to an aircraft.

In one embodiment, a gattling gun works that is mounted at the nose cone under portion of the aircraft, avionics grayboxes, vibration trays and a firearm, which is preferably a lightweight machine gun. The gattling gun works is designed for repeat fire power in intermittent operations while the air vents in the gattling machine gun works are designed for cooling the weapon. The grayboxes are located within the gattling works weapon and is designed for control within the cockpit of the aircraft. Both the weapon and the grayboxes have vibration trays mounted at each equipment base.

Alternate embodiments of the present invention include the use of a hood for enclosure, the use of a semi-automatic rifle in addition to or in lieu of the machine gun and firearms being secured to at least one wing on the aircraft.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. i is a perspective view of a first embodiment of the present invention installed on a twin propeller aircraft;

FIG. 2 is an expanded view of the embodiment of FIG. 1;

FIG. 3 is a perspective view of a second embodiment of the present invention installed on a twin propeller aircraft;

FIG. 4 is an expanded view of a third embodiment of the present invention installed on a twin engine aircraft;

FIG. 5 is a perspective view of a fourth embodiment of the present invention installed on a twin engine aircraft; and

FIG. 6 is a perspective view of a fifth embodiment of the present invention installed on a twin engine aircraft.

### DESCRIPTION OF THE PREFERRED EMBODIMENTS

For purposes of describing the preferred embodiment, the terminology used in reference to the numbered components in the drawings is as follows:
1. gattling works weapon
2. aircraft
3. nose cone
4. air vent
5. vibration tray
6. barrel
7. cockpit
8. graybox
9. hood
10. machine gun
11. platform
12. bracket
13. ammunition clip
14. brace
15. semi-automatic rifle
16. securing strap
17. pylon gunnery works
18. wing
19. first end
20. second end

FIG. 1 is a perspective view of a first embodiment of the present invention installed on a twin propeller airplane 2. The gattling works weapon 1 is mounted, either fixedly or rotatingly, at a predetermined location on the aircraft 2. The gattling works weapon 1 is preferably mounted on the nose cone 3 under portion of the aircraft 2 and has an exposed barrel 6. Air vents 4 located on the side of the gattling works weapon 1 allow for the cooling of the weapon 1. Avionics grayboxes 8 are designed for control within the cockpit 7 of the aircraft 2 while being located in the gattling works weapon 1.

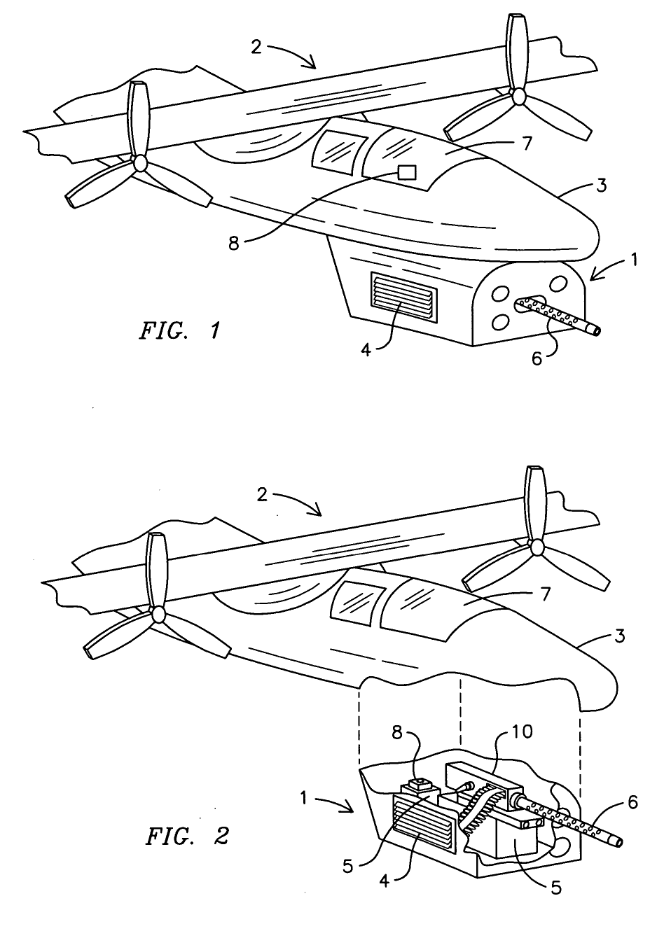

In FIG. 2, an expanded view of the embodiment of FIG. 1 is shown. The graybox 8 and the weapon 1 have vibration trays 5 mounted at each equipment base.

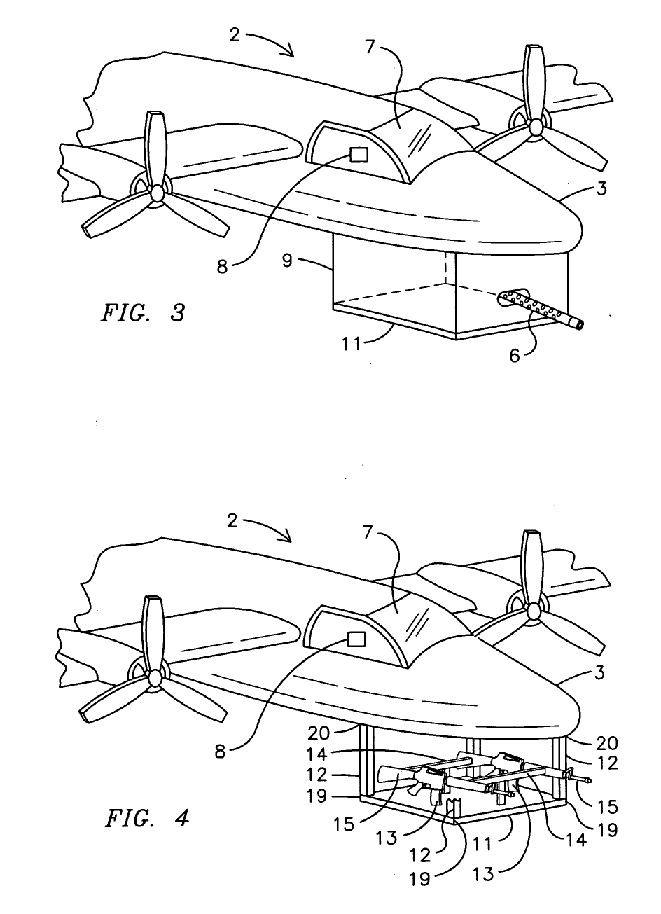

FIG. 3 shows a perspective view of a second embodiment of the present invention installed on a commercial twin propeller aircraft 2. The second embodiment includes a hood 9 for the enclosure of a machine gun 10 mounted on a platform 11. The hood is preferably made of sheet metal while the machine gun 10 is preferably lightweight and similar in design to those used by United States secret service agents and other governmental agencies in the United States. Although the use of a machine gun 10 is preferred, other firearms, such as a semi-automatic rifle, may be used in addition to or in lieu of the machine gun 10.

FIG. 4 shows a third embodiment of the present invention installed on a twin engine aircraft 2 wherein a hood 9 is not utilized. Instead, a securing means, such as at least one bracket 12 having a first end 19 and a second end 20, are used for securing a platform 11 to the aircraft 2 so as to permit an open view from all areas of the platform 11. The first end 19 of the at least one bracket 12 is secured to the platform 11 while the second end 20 is secured to a predetermined location on the aircraft 2 itself, preferably under the nose cone 3, by drilling holes into the aircraft 2. At least one semi-automatic rifle 15 is secured to the platform 11 in a fixed or rotating manner. Ammunition clips 13 provide an ample amount of ammunition to the semi-automatic rifle 15. If a plurality of semi-automatic rifles 15 are used, they are preferably grouped and held together by braces 14. Because the hood 9 for enclosure is eliminated in this embodiment of the present invention, a large amount of weight is reduced, thereby increasing the rate of speed at which the aircraft 2 may travel.

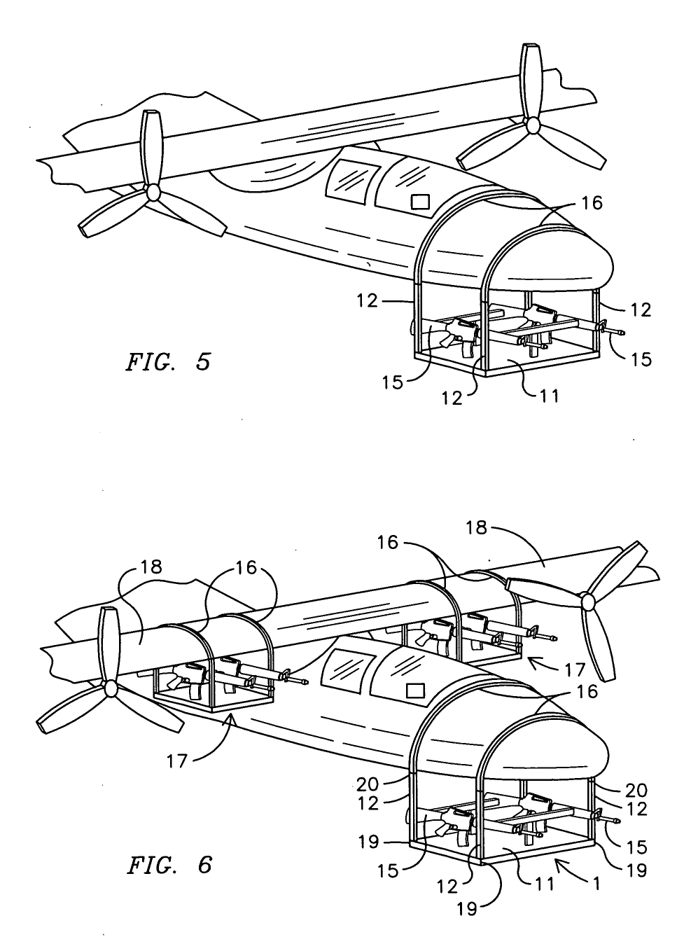

With respect to FIG. 5, a fourth embodiment of the present invention installed on a twin engine aircraft 2 is shown. Similar to the third embodiment of the present invention, the fourth embodiment utilizes an open platform 11 setting so as to reduce the amount of weight added onto the aircraft 2. In the fourth embodiment, however, securing straps 16 are added to provide additional strength in securing the platform 11 to the aircraft 2. The securing straps 16, which are preferably attached to the nose cone 3 of the aircraft 2, may also be used in securing at least one gattling works weapon 1, machine gun 10 or semi-automatic rifle 15 to the nose cone 3.

Finally, FIG. 6 shows a fifth embodiment of the present invention installed on a twin engine aircraft 2. In the fifth embodiment, at least one firearm, including gattling works weapons 1, semi-automatic rifles 15 and/or pylon gunnery works 17, is secured to a predetermined location on the aircraft 2, such as at least one wing 18 of the aircraft 2, via a securing means, such as securing straps 16 or brackets 12. In addition, at least one firearm, also including gattling works weapons 1, semi-automatic rifles 15 and/or pylon gunnery works 17, may be secured to another predetermined location on the aircraft 2, such as the nose cone 3 of the aircraft 2, via a securing means, such as securing straps 16 or brackets 12.

Although five embodiments of the present invention are shown, users may modify an aircraft 2 using various pieces of the kit not described in detail herewith, such as combining a hood 9 with a pylon gunnery works 17. In addition, although the predetermined locations for mounting firearms are shown and described as the nose cone 3 and at least one wing 18, other locations for mounting firearms on the aircraft 2 may be utilized. Thus, the interchangeability of the various pieces of the kit allow for a customized jungle fighter to be made.

Although not shown, propellers may also be included in the jungle aircraft conversion kit. The kit enables the conversion of existing propeller or twin engine aircraft to a fighter aircraft in a cost efficient manner.

Although only a few embodiments of the present invention have been described in detail hereinabove, all improvements and modifications to this invention within the scope or equivalents of the claims are included as part of this invention.

Having thus described my invention, I claim:

1. A jungle fighter aircraft conversion kit comprising:
at least one firearm; and
a means for mounting said at least one firearm to a predetermined location on an aircraft.

2. The jungle fighter aircraft conversion kit of claim 1 wherein:
said at least one firearm is a gattling gun works.

3. The jungle fighter aircraft conversion kit of claim 1 wherein:
said at least one firearm is a machine gun.

4. The jungle fighter aircraft conversion kit of claim 1 wherein:
said at least one firearm is a semi-automatic rifle.

5. The jungle fighter aircraft conversion kit of claim 1 wherein:
said at least one firearm is a pylon gun works.

6. The jungle fighter aircraft conversion kit of claim 1 wherein:
said predetermined location on an aircraft is a nose cone.

7. The jungle fighter aircraft conversion kit of claim 1 wherein:
said predetermined location on an aircraft is at least one wing.

8. The jungle fighter aircraft conversion kit of claim 1 wherein:
said means for mounting has a first end and a second end; and
said second end of said means for mounting is secured to a predetermined location on an aircraft.

9. The jungle fighter aircraft conversion kit of claim 8 wherein:
said means for mounting said at least one firearm to a predetermined location on an aircraft is at least one bracket.

10. The jungle fighter aircraft conversion kit of claim 8 wherein:
said means for mounting said at least one firearm to a predetermined location on an aircraft is at least one strap.

11. The jungle fighter aircraft conversion kit of claim 8 wherein:
said predetermined location on an aircraft is a nose cone.

12. The jungle fighter aircraft conversion kit of claim 8 wherein:
said predetermined location on an aircraft is at least one wing.

13. The jungle fighter aircraft conversion kit of claim 8 further comprising:
a platform secured to said first end means for mounting said at least one firearm to a predetermined location on an aircraft.

14. The jungle fighter aircraft conversion kit of claim 13 further comprising:
a hood is located on said platform and encloses said platform.

15. The jungle fighter aircraft conversion kit of claim 1 wherein:
said means for mounting said at least one firearm to a predetermined location on an aircraft is fixed.

16. The jungle fighter aircraft conversion kit of claim 1 wherein:
said means for mounting said at least one firearm to a predetermined location on an aircraft is rotating.

17. The jungle fighter aircraft conversion kit of claim 8 wherein:
said at least one firearm is a gattling gun works.

18. The jungle fighter aircraft conversion kit of claim 8 wherein:
said at least one firearm is a machine gun.

19. The jungle fighter aircraft conversion kit of claim 8 wherein:
said at least one firearm is a semi-automatic rifle.

20. The jungle fighter aircraft conversion kit of claim 8 wherein:
said at least one firearm is a pylon gun works.

21. The jungle fighter aircraft conversion kit of claim 8 wherein:
said means for mounting said at least one firearm to a predetermined location on an aircraft is fixed.

22. The jungle fighter aircraft conversion kit of claim 8 wherein:
said means for mounting said at least one firearm to a predetermined location on an aircraft is rotating.

23. The jungle fighter aircraft conversion kit of claim 2 further comprising:
at least one avionics graybox located in a cabin of said aircraft.

24. The jungle fighter aircraft conversion kit of claim 8 further comprising:
at least one avionics graybox located in a cabin of said aircraft.
